(19) United States
(12) Patent Application Publication
(10) Pub. No.: US 2025/0184818 A1
(43) Pub. Date: Jun. 5, 2025

(54) VOICE PACKET COMBINATION MECHANISM

(71) Applicant: Nokia Technologies Oy, Espoo (FI)

(72) Inventors: Ping YUAN, Beijing (CN); Ping Ping WEN, Shanghai (CN)

(21) Appl. No.: 18/869,567

(22) PCT Filed: Aug. 10, 2022
(86) PCT No.: PCT/CN2022/111570

§ 371 Date: Nov. 26, 2024

(51) Int. Cl. H04W 28/06; H04W 28/02

(52) U.S. Cl. CPC H04W 28/065; H04W 28/0236

(57) ABSTRACT

Embodiments of the present disclosure relate to voice packet combination. A terminal device receives, from a network device, control information for controlling voice packet combining at the terminal device, and determines the voice packet combining based on the control information, and then the terminal device performs the voice packet combining; and transmits the combined voice packet to the network device. The solution enables the network to control the packet combining in terminal device based on control information.

### FIELD

Various example embodiments relate to the field of telecommunication and in particular, to methods, devices, apparatuses and a computer readable storage medium for voice packet combination mechanism.

### BACKGROUND

In the communications area, there is a constant evolution ongoing in order to provide efficient and reliable solutions for utilizing wireless communication networks. Each new generation has it owns technical challenges for handling the different situations and processes that are needed to connect and serve devices connected to the wireless network. To meet the demand for wireless data traffic having increased since deployment of 4th generation (4G) communication systems, efforts have been made to develop an improved 5th generation (5G) or pre-5G communication system. The new communication systems can support various types of service applications for terminal devices.

In recent communication technologies, packet combination is considered, instead of containing one speech frame encapsulated in each Real-time Transport Protocol (RTP) packet/payload or transmitting one speech frame in one uplink transmission.

### SUMMARY

In general, example embodiments of the present disclosure provide a solution for voice packet combination mechanism.

In a first aspect, there is provided a terminal device. The terminal device comprises at least one processor and at least one memory storing instructions. The instructions, when executed by the at least one processor, cause the terminal device at least to: receive, from a network device, control information for controlling voice packet combining at the terminal device; determine the voice packet combining based on the control information; perform the voice packet combining; and transmit the combined voice packet to the network device.

In a second aspect, there is provided a network device. The network device comprises at least one processor and at least one memory storing instructions. The instructions, when executed by the at least one processor, cause the network device at least to: determine control information for controlling voice packet combining at a terminal device; transmit the control information to the terminal device; and receive the combined voice packet from the terminal device.

In a third aspect, there is provided a method. The method comprises receiving, at a terminal device from a network device, control information for controlling voice packet combining at the terminal device; determining the voice packet combining based on the control information; performing the voice packet combining; and transmitting the combined voice packet to the network device.

In a fourth aspect, there is provided a method. The method comprises determining, at a network device, control information for controlling voice packet combining at a terminal device; transmitting the control information to the terminal device; and receiving the combined voice packet from the terminal device.

In a fifth aspect, there is provided an apparatus. The apparatus comprises means for receiving, at a terminal device from a network device, control information for controlling voice packet combining at the terminal device; means for determining the voice packet combining based on the control information; means for performing the voice packet combining; and means for transmitting the combined voice packet to the network device.

In an sixth aspect, there is provided an apparatus. The apparatus comprises means for determining, at a network device, control information for controlling voice packet combining at a terminal device; means for transmitting the control information to the terminal device; and means for receiving the combined voice packet from the terminal device.

In a seventh aspect, there is provided a non-transitory computer readable medium comprising program instructions for causing an apparatus to perform at least the method according to any one of the above third to fourth aspect.

In an eighth aspect, there is provided a non-transitory computer readable medium comprising program instructions stored thereon for performing at least the method according to any one of the above third to fourth aspect.

In a ninth aspect, there is provided a computer program comprising instructions, which, when executed by an apparatus, cause the apparatus at least to: receive, from a network device, control information for controlling voice packet combining at the terminal device; determine the voice packet combining based on the control information; perform the voice packet combining; and transmit the combined voice packet to the network device.

In a tenth aspect, there is provided a computer program comprising instructions, which, when executed by an apparatus, cause the apparatus at least to: determine control information for controlling voice packet combining at a terminal device; transmit the control information to the terminal device; and receive the combined voice packet from the terminal device.

In a eleventh aspect, there is provided a terminal device. The terminal device comprises: receiving circuitry configured to receive, from a network device, control information for controlling voice packet combining at the terminal device; determining circuitry configured to determine the voice packet combining based on the control information; performing circuitry configured to perform the voice packet combining; and transmitting circuitry configured to transmit the combined voice packet to the network device.

In a twelfth aspect, there is provided a network device. The network device comprises: determining circuitry configured to determine control information for controlling voice packet combining at a terminal device; transmitting circuitry configured to transmit the control information to the terminal device; and receiving circuitry configured to receive the combined voice packet from the terminal device.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which embodiments of the present disclosure may be implemented;

FIG. 2 is a schematic diagram of VoIP packet transmission in a scenario where packet combination is not performed;

FIG. 3 is a schematic diagram of VoIP packet with 40 ms periodicity in talkspurt due to packet combining;

FIG. 4 is a schematic diagram of configured grant for VoIP packets transmission;

FIG. 5 is a schematic diagram of configured grant and dynamic scheduling for VoIP packets combination;

FIG. 6 illustrates an overhead change example;

FIG. 7 illustrates a flowchart illustrating communication between the terminal device and the network device according to some embodiments of the present disclosure;

FIG. 8 illustrates a schematic diagram illustrating a method of voice packet combination in accordance with some embodiments of the present disclosure;

FIG. 9 illustrates a schematic diagram illustrating a method of voice packet combination in accordance with some embodiments of the present disclosure;

FIG. 10 illustrates a simplified block diagram of an apparatus that is suitable for implementing embodiments of the present disclosure; and

FIG. 11 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure.

The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

3GPP has defined a work item for Rel-17 on non-terrestrial networks (NTN) in RP-201256 and the further enhancement will be continued in Rel-18 in WID RP-220953.

For Rel-18, one objective is to support VoNR (VoIP over NR) in NTN for commercial handset terminals.

| | |
|---|---|
| 4.1.1 | Coverage enhancement |

Have a 1-TU 6-month study phase focusing on the following (to derive clear & limited scope):

| • | Evaluate the coverage performance and identify the candidate physical radio channels that | |
|---|---|---|
| | have coverage issues specific to NTN with following target services taking into account the | |
| | studies in TR38.830 where appropriate, as well as general coverage enhancement | |
| | techniques specified in Rel-18 [RAN1,RAN2,RAN4] | |
| | ∘ | VoIP and low-data rate services for commercial handset terminals |

The following items are shown as examples of areas to consider in the next step of the study. The
actual items for study will be based on the evaluation of coverage issues specific to NTN identified
above.

| • | NTN-specific repetitions enhancements beyond techniques covered in Rel-17 CovEnh WI | |
|---|---|---|
| | for the relevant channels | |
| • | NTN-specific techniques for improved diversity and/or reduced polarization loss | |
| • | Improved performance of low-rate codecs in link budget limited situation including | |
| | reducing RAN protocol overhead for VoNR | |
| | ∘ | NOTE: Intent is not to introduce a new codec. |

RAN1 has started the Rel-18 NR NTN VoNR discussion at RAN1-109e. In the discussion, voice packet combining is one hot topic since it may save the PDCCH usage and improve the system voice user capacity. For example, there is discussion about two voice frames per 40 ms should be allowed if it provides performance gain, and how to apply packet combination in NR NTN in next RAN1 meeting is encouraged to report.

Agreement
For VoIP, AMR (Adaptive Multi-Rate) 4.75 kbps (TBS of 184 bits without CRC in physical layer)
with 20 ms data arriving interval is used in the evaluations.

| • | Each packet is transmitted within 20 ms, if packet combining is not used. | |
|---|---|---|
| | ∘ | Companies are encouraged to evaluate at least packet transmission without |
| | | combining |
| | ∘ | Companies are encouraged to report how to apply packet combining, if used. |
| | ∘ | Note: in packet combining, two packets can be combined into a single packet at TX |

| side | |
|---|---|
| - | Companies should report the impact on E2E latency |

| | |
|---|---|
| • | VoIP is evaluated only in LEO scenario. |
| • | Note 1: PRB/MCS/TBS determinations are discussed separately |
| • | Note 2: companies should report if HARQ is used in the evaluations, and if evaluations |
| | depart from the assumption that each packet is transmitted within 20 ms |

In order to more clearly introduce embodiments of the present disclosure, the following is a description of Configured Grant. For PUSCH scheduling, RAN2 agreed in Rel-17 that network can schedule UE via configured grant (CG) in NTN, and both Type 1 and Type 2 configured grant are feasible in NTN.

Take the terminal device is UE for example, configured grant can allocate radio resources to UEs for a sequence of TTIs that repeats with a certain periodicity via one PDCCH signal. It can reduce the usage of PDCCH resources for VoIP users due to scheduling recurring uplink allocations for VoIP packets with a single PDCCH command. However, the single PDCCH command means voice packets are scheduled automatically with the same MCS and PRBs (same TBS) in multiple (periodic) PUSCH transmission occasions.

If multiple speech frames are encapsulated in one RTP packet (e.g. 2 or 3 or 4 speech frames), compared to 1 speech frame per RTP packet, the increased VoIP payload requires bigger Transport Block Size (TBS) to accommodate the RTP packet. Or if multiple RTP packets are transmitted in one uplink transmission, compared to transmit one RTP packet in one uplink transmission, the increased number of RTP packets requires bigger Transport Block Size (TBS) to accommodate the RTP packets. However, since the packet combining is implemented in UE, if the packet combing status is unknown to network, network may not schedule the UE properly with suitable uplink TBS in configured grant. Furthermore, in an uplink coverage limited scenario (e.g. Non-terrestrial network (NTN)), network may not schedule UE with the bigger TBS to accommodate the combined VoIP payload due to UE's power limitation (e.g. Power Headroom Report (PHR)<0).

First, for Configured Grant, if UE autonomously decides when to perform packet combining during the voice call (e.g. during the VoIP talkspurt), the fixed TBS allocated by CG may not accommodate the combined VoIP packets. In this case, the network has to perform additional dynamic scheduling to deliver the remaining VoIP payload left from previous CG transmission. It will cost additional PDCCH grant for dynamic scheduling which will reduce the gain of CG (i.e. PDCCH saving). In addition, the long propagation delay will introduce the latency with additional dynamic scheduling in NTN which will have impact on the voice service quality. Furthermore, it will waste the CG allocated TBS in some occasions due to the arrival of RTP packets changed from 20 ms to 40 ms. If the situation last for quite a long time, it may cause the CG not useful at all.

Second, if the uplink coverage is the bottleneck, the double size of RTP packet (with VoIP packet combining) or double size of TBS requirement to accommodate combined VoIP packets may not be transmitted in one PUSCH transmission due to UE's power limitation. In this case, the network may have to schedule multiple small TBS with the available PHR hence UE has to perform the RLC segmentation for the RTP packet. With the more RLC segmentations, the protocol overhead will increase since MAC (Medium Access Control)/RLC and CRC overhead has to be added for each segment.

In summary, the VoIP packet combination autonomously decide by UE may cause the resource waste in both PDCCH and allocated PUSCH, which may result in configured grant feature useless. Furthermore, in uplink coverage limitation case, the VoIP packet combination will increase the protocol overhead, E2E delay and cost more PDCCH which will decrease the cell's VoIP user capacity in the end. According to some embodiments of the present disclosure, there is providing a solution for solving the above problems.

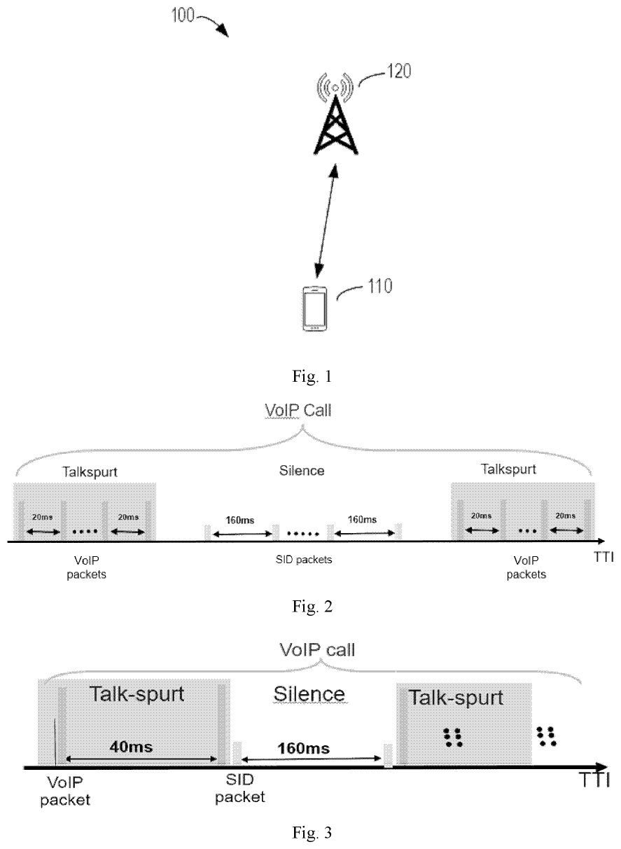

Principle and embodiments of the present disclosure will be described in detail below with reference to the accompanying drawings. Reference is first made to FIG. 1, which illustrates an example communication system 100 in which embodiments of the present disclosure may be implemented. The system 100 includes terminal device 110 and network device 120. The network device 120 may serve respective areas (also called as cells) using a frequency band in both downlink and uplink. Such a frequency band may also be referred to as an operating frequency band of the corresponding network device.

The terminal device 110 is capable of connecting and communicating in an uplink and downlink with the network devices 120 as long as the terminal device 110 located within the corresponding cells. In communication systems, an uplink refers to a link in a direction from the terminal device 110 to the network device 120, and a downlink refers to a link in a direction from the network device 120 to the terminal device 110. In some embodiments, the communication between the terminal device 110 and the network device 120 may be transmitting the voice packet from the terminal device 110 to the network device 120. In the communication, voice packet combination at terminal device 110 can be applied. In some embodiments, the network device 120 can control the voice packet combination at terminal device 110 by transmitting control information to the terminal device 110.

It is to be understood that the number of the network device 120 and the terminal devices 110 is only for the purpose of illustration without suggesting any limitations. The system 100 may include any suitable number of network devices 120 and terminal devices 110 adapted for implementing embodiments of the present disclosure.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In order to more clearly introduce the scheme of the embodiment of the present disclosure, firstly, the transmission mechanism of voice packets is introduced. In general, each VoIP packet is transmitted with the periodicity 20 ms if packet combination is not used. FIG. 2 is a schematic diagram of VoIP packet transmission in a scenario where packet combination is not performed. More specifically, FIG. 2 shows a VoIP packet with 20 ms periodicity in talkspurt. In this case, one speech frame is encapsulated in each RTP packet. The TB size to accommodate (transmit) a VoIP packet should consider the factors such as VoIP payload, RTP/UDP/IP header and MAC/RLC/PDCP headers. As is shown in Table 1 below is one TBS calculation example with the assumption that the VoIP AMR codec is 4.75 Kbps in bandwidth-efficient mode (refer to 26.114 for details calculation on RTP payload for different VoIP codec).

TABLE 1

| | | | | VoIP payload | |
|---|---|---|---|---|---|
| | | | RTP/UDP/IP | (One speech | |
| MAC | RLC | PDCP | Header | frame in each | |
| Header | Header | Header | (RoHC) | RTP payload) | TBS |
| 16 bits | 8 bits | 16 bits | 40 bits | 112 bits | 192 bits |

If packet combination is considered, instead of containing one speech frame encapsulated in each RTP packet/payload, UE may include multiple speech frames per RTP packet (e.g. 2 or 3 or 4 speech frames) or transmit multiple RTP packets in one uplink transmission. If two speech frames are encapsulated in a RTP payload, the VoIP packet will be transmitted with periodicity 40 ms but the required TBS to accommodate the RTP packet should be increased accordingly. FIG. 3 is a schematic diagram of VoIP packet with 40 ms periodicity in talkspurt due to packet combining.

With the same assumption as previous calculation, we can see the VoIP payload should be doubled since two speech frames in one RTP payload. If we assume the overhead is same in both cases, then the required TBS is 304 bits as shown in Table 2.

TABLE 2

| | | | | VoIP payload | |
|---|---|---|---|---|---|
| | | | RTP/UDP/IP | (Two speech | |
| MAC | RLC | PDCP | Header | frames in each | |
| Header | Header | Header | (RoHC) | RTP payload) | TBS |
| 16 bits | 8 bits | 16 bits | 40 bits | 224 bits | 304 bits |

There is another example from R2-164579 where the application encapsulates up to four packets in one RTP packet. As shown in Table 3, the required TBS change from 256 bits to 720 bits accordingly when the number of speech frames in one RTP packet change from 1 to 4. It should be noted that Application encapsulation of speech frames in one RTP packet requires updates to the VoLTE service description.

TABLE 3

| | | | | | | | | | Inter tx | | |
|---|---|---|---|---|---|---|---|---|---|---|---|
| | Application | | RTP header | | | | | | time | Total | TBS |
| Codec | encapsulation | Payload | (ROHC) | PDCP | RLC | MAC | BSR | PHR | (ms) | (bytes) | (bits) |
| EVS 7.2 kbps | 1 | 18 | 3 | 2 | 2 | 1 | 4 | 2 | 20 | 32 | 256 |
| EVS 7.2 kbps | 2 | 19*2 | 3 | 2 | 2 | 1 | 4 | 2 | 40 | 52 | 416 |
| EVS 7.2 kbps | 3 | 19*3 | 3 | 2 | 2 | 1 | 4 | 2 | 60 | 71 | 568 |
| EVS 7.2 kbps | 4 | 19*4 | 3 | 2 | 2 | 1 | 4 | 2 | 80 | 90 | 720 |

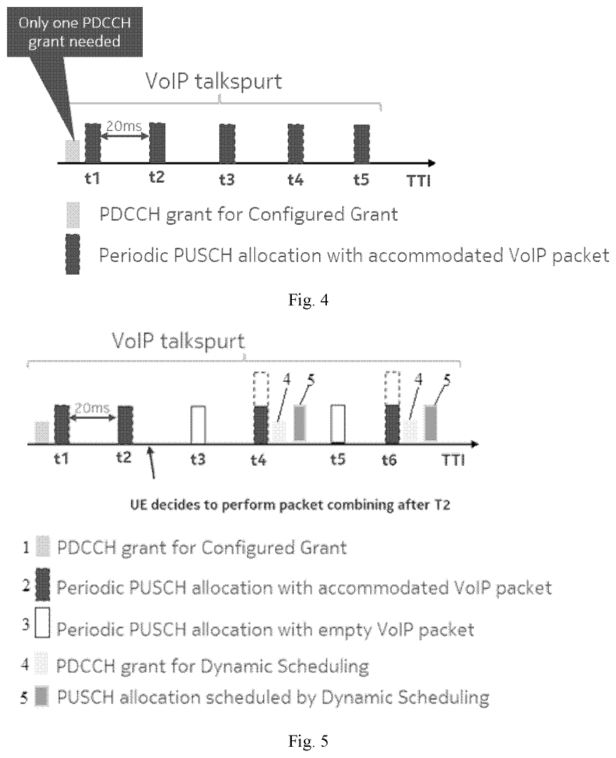

As mentioned above, the single PDCCH command means voice packets are scheduled automatically with the same MCS and PRBs (same TBS) in multiple (periodic) PUSCH transmission occasions. For example, the network may schedule the configured grant with periodicity 20 ms to deliver the VoIP packets in talkspurt where fixed TBS (e.g. 256 bits) is used in each PUSCH occasion. FIG. 4 is a schematic diagram of Configured Grant for VoIP packets transmission. More specifically, FIG. 4 shows a configured grant with periodicity 20 ms to save PDCCH resource for VoIP packets.

In some schemes that UE autonomously decides when to perform packet combining during the voice call, as mentioned above, the arrival of RTP packets may be changed from 20 ms to 40 ms, as shown in FIG. 5, FIG. 5 is a schematic diagram of Configured Grant and dynamic scheduling for VoIP packets combination. As illustrated in FIG. 5, network may allocate the fixed TBS via configured grant (CG) at time t1, t2, t3, t4, t5 and t6 with periodicity 20 ms for a voice call. If the UE decides to perform packet combining after t2, it will cause: 1) The RTP packet arrival will change from 20 ms to 40 ms. 2) The required TBS to accommodate the combined VoIP payload will be almost doubled.

Due to packet arrival periodicity change, the allocated TBS at t3 and t5 will be wasted as there is no RTP packet to be transmitted at that time. Due to the VoIP payload is almost doubled, the TBS allocated at t4 and t6 cannot accommodate the RTP packet hence a corresponding dynamic scheduling (with PDCCH in block marked by 4 and PUSCH in block marked by 5) has to be performed.

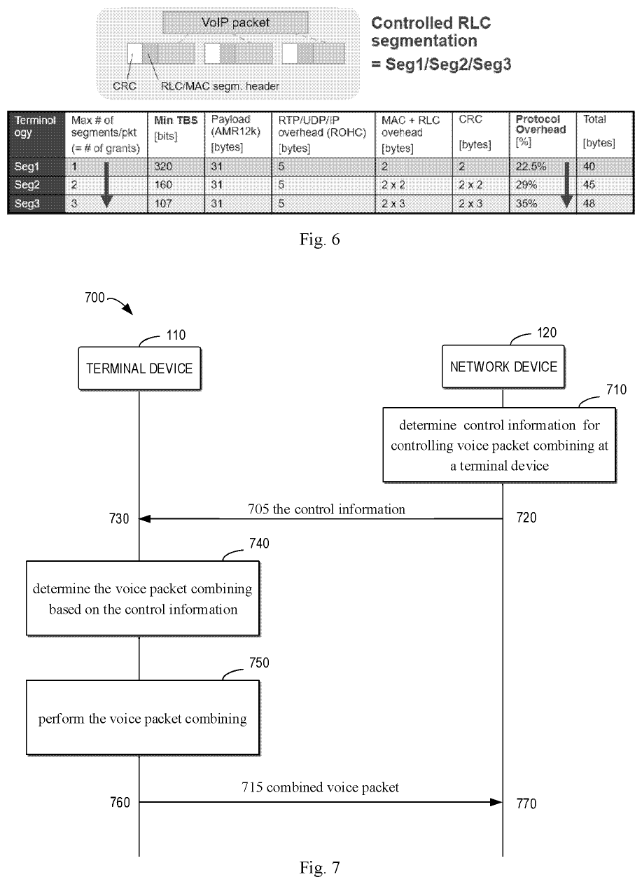

As mentioned above, when the double size of RTP packet (with VoIP packet combining) or TBS to accommodate combined VoIP packets cannot be transmitted in one PUSCH transmission due to UE's power limitation, the network may have to schedule multiple small TBS with the available PHR hence UE has to perform the RLC segmentation for the RTP packet. With reference to FIG. 6, FIG. 6 illustrates an overhead change example showing protocol overhead for RLC segmentation. As shown in FIG. 6, with the more RLC segmentations, the protocol overhead will increase since MAC/RLC and CRC overhead has to be added for each segment. Furthermore, the more RLC segments, the more PDCCH will be used which is also a waste of system resource. Moreover, considering the RTT in NTN (LEO case) can be 42 ms, the more RLC segments to be transmitted the more E2E delay will be increased to deliver all the segments in HARQ process especially in uplink HARQ mode A where the retransmission is based on PUSCH decoding result in network.

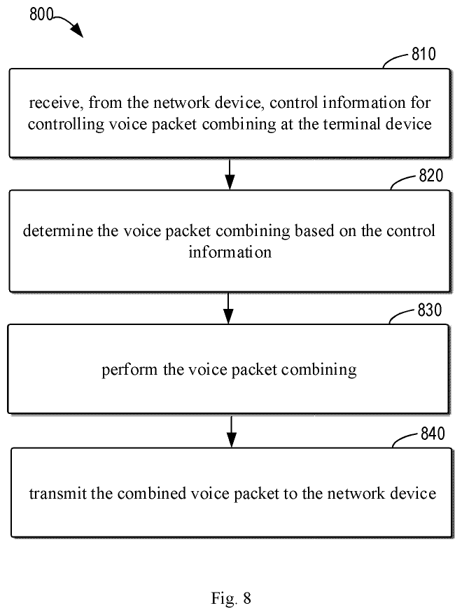

FIG. 7 illustrates a flowchart 700 illustrating communication between the terminal device 110 and the network device 120 according to some embodiments of the present disclosure. As shown in FIG. 7, the network device 120 may determine (710) control information 705 for controlling voice packet combining at a terminal device 110. Then the network device 120 may transmit (720) the control information 705 to the terminal device 110. Accordingly, the terminal device 110 can receive (730), from the network device 120, control information 705 for controlling voice packet combining at the terminal device 110. The terminal device 110 may determine (740) the voice packet combining based on the control information 705, and may perform (750) the voice packet combining. The terminal device 110 may transmit (760) the combined voice packet 715 to the network device 120. Accordingly, the network device 120 may receive (770) the combined voice packet 715 from the terminal device 110. In this way, the network device 120 can configure the rules on how and whether the terminal device 110 can apply the voice packet combining in the terminal device 110.

In some embodiments, the voice packet combining may be VoIP packet combining, and then, the embodiments may introduce a new mechanism on how to control the VoIP packet combining (i.e. packet aggregation) in the terminal device 110, in which network can configure the rules on how and whether the terminal device 110 can apply the packet combining. In some embodiments, the voice packet is corresponding to a Voice over Internet Protocol (VoIP) speech frame.

In some embodiments, the network device 120 may one or more information of the control information via Radio Resource Control (RRC) or System Information Block (SIB). Accordingly, the terminal device 110 may receive one or more information of the control information via RRC or SIB.

In some embodiments, the control information from the network device 120 received by the terminal device 110 may include a TBS threshold for the voice packet combining at the terminal device 110. On the side of the network device 120, network device 120 may transmit the TBS threshold to the terminal device.

In some embodiments, the terminal device 110 may transmit, to the network device 120, radio channel conditions of the terminal device 110 for determining the TBS threshold by the network device 120. Accordingly, the network device 120 may receive, from the terminal device 110, radio channel conditions of the terminal device 110; and determine the TBS threshold as the control information based on the radio channel conditions of the terminal device 110. In some embodiments, the network device 120 may determine a TBS threshold as the control information based on a configured TBS in Configured Grant (CG).

In some embodiments, in order to perform the voice packet combining, the terminal device 110 may determine a plurality of voice packets to be combined if the required Transport Block Size (TBS) to accommodate combined packets is less than the TBS threshold; and then combine the plurality of voice packets into a single packet for uplink transmission. In some embodiments, the terminal device 110 may determine the number of voice packets to be combined in a single packet based on the TBS threshold and an applied voice codec rate.

According to these embodiments above, for example, network can configure a TBS threshold for packet combining to UE via RRC or SIB. The UE can perform packet combining (i.e. two or more VoIP speech frames or VoIP packets combined into a single packet for uplink transmission) only if the required TBS to accommodate combined packets is less than the network defined TBS threshold. In some embodiments, UE may decide the number of speech frames or VoIP packets to be combined in a single packet based on the TBS threshold and the applied voice codec rate (e.g. different data rate in AMR-WB, AMR-NB or EVS (Enhance Voice Services)). In some embodiments, network may configure the TBS threshold based on the supported TBS according to UE's radio channel conditions and/or the configured TBS in CG.

In some other embodiments, the control information from the network device 120 received by the terminal device 110 may include a time-delay threshold for the voice packet combining at the terminal device. In some embodiments, on the side of the network device 120, the network device 120 may determine a time-delay threshold as the control information based on scheduling strategy of the network device 120, the scheduling strategy may include scheduling priority for scheduling voice packets, and the network device 120 may transmit the time-delay threshold to the terminal device 110.

In some embodiments, in order to perform the voice packet combining, the terminal device 110 may determine a plurality of voice packets to be combined if an offset from the time of the packet generation to the time of the voice packet transmission is less than the time-delay threshold; and combine the plurality of voice packets into a single packet for uplink transmission.

According to these embodiments above, for example, the network can configure a time-delay threshold for packet combining to the UE via RRC or SIB. The UE can perform packet combining only if the offset from the time of the VoIP packet generation to the time of voice packet transmission is less than the time-delay threshold. In some embodiments, the threshold can be 20 ms, 40 ms, 60 ms or 80 ms which is corresponding to 1,2,3 or 4 voice speech frames or voice packet combining. In some embodiments, the network may configure the time-delay threshold based on network scheduling strategy. For example, the network should prioritize the scheduling for the packets with higher delay to meet the end to end delay target. The network may assign different scheduling priority for packets based on different time-delay threshold in the scenario where different UE may be configured with different time-delay threshold.

In some embodiments, the network device 120 may transmit, to the terminal device 110, a flag indicating whether the voice packet combining at the terminal device 110 is allowed. In some embodiments, the network device 120 may transmit the flag via Radio Resource Control (RRC) or System Information Block (SIB). Accordingly, the terminal device 110 can receive the flag via RRC or SIB.

In some embodiments, in order to perform the voice packet combining, the terminal device 110 may receive, from the network device 120, the flag indicating whether the voice packet combining at the terminal device 110 is allowed, and may determine the voice packet combining at the terminal device is allowed and then may base on determining that the voice packet combining at the terminal device is allowed, performing the voice packet combining.

According to these embodiments above, for example, The network can configure ON/OFF flag to the UE on whether packet combining is allowed via RRC or SIB. In some embodiments, the network may disable the packet combining function to limit the required TBS for VoIP payload accommodation when the UE is in cell edge where the uplink coverage is a bottleneck. In some embodiments, the control information from the network device 120 received by the terminal device 110 may include at least one Reference Signal Receiving Power (RSRP) threshold.

In some embodiments, on the side of the network device 120, the network device 120 may determine at least one RSRP threshold as the control information, a RSRP threshold may be corresponding to a packet combination level used for the terminal device 110 to perform the voice packet combining, and the network device 120 may transmit the at least one RSRP threshold to the terminal device 110.

In some embodiments, the terminal device 110 may receive, from the network device 120, a RSRP threshold for the voice packet combining at the terminal device. And in some embodiments, in order to perform the voice packet combining, the terminal device 110 may determine the voice packet combining is allowed if a measured RSRP in the terminal device is higher than the RSRP threshold, and then perform the voice packet combining.

In some embodiments, the terminal device 110 may receive, from the network device 120, a plurality of RSRP thresholds for the voice packet combining at the terminal device. And in some embodiments, in order to perform the voice packet combining, the terminal device 110 may determine, based on the plurality of RSRP thresholds, a packet combination level corresponding to a measured RSRP, and then perform the voice packet combining based on the number of voice packets corresponding to the packet combination level. In some embodiments, the control information may include one or more information mentioned above.

According to these embodiments above, for example, the network may configure one or more RSRP threshold(s) via RRC or SIB to facilitate the UE to decide whether packet combining is allowed and/or the maximum applied packet combining level. In some embodiments, if the measured RSRP in the UE is below or equal to a RSRP threshold, the packet combing is not allowed. In some other embodiments, the network may configure multiple RSRP thresholds for different packet combination level (say PCRSRP-threshold-level2, PCRSRP-thresold-level3 . . . to PCRSRP-threshold-levelX), the UE can apply the maximum packet combination level only if the measured RSRP is higher than the corresponding RSRP threshold, for example, if the measured RSRP is higher than PCRSRP-threshold-level2 but lower than or equal to PCRSRP-threshold-level3, then the number of packets can be combined is 2. If the measured RSRP is higher than PCRSRP-threshold-level3 but lower than or equal to PCRSRP-threshold-level4, then the number of packets can be combined is 3.

The present disclosure also provides a solution for reporting packet combining status. The following describes the scheme of the terminal device 110 reporting packet combining status to the network device 120 through some embodiments. It should be noted that these embodiments can depend on the above-described embodiments, that is, the scheme of the terminal device 110 reporting packet combining status to the network device 120 can be part of the above-described packet combining scheme. Alternatively, these embodiments may exist independently of the embodiments described above, that is, the scheme of the terminal device 110 reporting packet combining status to the network device 120 may be implemented as an independent scheme.

In some embodiments, the terminal device 110 may report a status of the voice packet combining to the network device 120, accordingly, the network device 120 can receive the report of status of the voice packet combining from the terminal device 110. In some embodiments, the report including at least one of: the number of combined VoIP speech frames in a single packet for uplink transmission: the number of VoIP packets in a single packet for uplink transmission; an offset from the time of the VoIP packet generation to the time of the voice packet transmission at the terminal device; and information indicating whether the voice packet combining is performed or to be performed.

In some embodiments, the terminal device 110 may report the status of the voice packet combining based on determining that the number of Voice over Internet Protocol (VoIP) speech frames in a single packet for uplink transmission or the number of VoIP packets in a single packet for uplink transmission has changed or to be changed. In some embodiments, in the report, the terminal device 110 may report the number of combined VoIP speech frames or VoIP packets in a single packet for uplink transmission. In some embodiments, the terminal device 110 may report the status of the voice packet combining based on determining that an offset from the time of the VoIP packet generation to the time of the voice packet transmission is changed or to be changed.

In some embodiments, when there is no control information received from the network device 120 or trigger condition, the terminal device 110 can report the packet combining status to the network device, that is, the terminal device 110 can automatically report the status above. In some embodiments, in the report, the terminal device 110 may report the offset from the time of the VoIP packet generation to the time of the voice packet transmission. In some embodiments, in the report, the terminal device 110 may report information indicating whether the voice packet combining is performed or to be performed.

In some embodiments, the terminal device 110 may report the status of the voice packet combining via Media Access Control Control Element (MAC CE) or RRC. On the side of the network device 120, the network device 120 may receive the report via MAC CE or RRC.

With reference to the previously described embodiments, in some embodiments, the network device 120 may update the control information based on the report. According to these embodiments above, for example, UE may report the packet combining status to network (network device 120). The report may be triggered in the case the number of VoIP speech frames in a single packet for uplink transmission has changed or to be changed. (e.g. the number of combined VoIP speech frames is changed or to be changed) or the number of VoIP packets in a single packet for uplink transmission has changed or to be changed.

Alternatively, the report may be triggered in the case the time offset (from the time of the VoIP packet generation to the time of packet combining/transmission) is changed or to be changed. The content may include the number of combined VoIP speech frames or VoIP packets in a single packet for uplink transmission. Alternatively, the content may include whether packet combination is performed or will be performed. Alternatively, the content may include the time offset (from the time of the VoIP packet generation to the time of packet combining/transmission).

UE may report the status to network via MAC CE. Alternatively, UE may report the status via RRC. With the reported packet combining status, network can derive the change of the required TBS to accommodate the VoIP payload hence (re) schedule a suitable TBS in Configured Grant. Alternatively, network can control the packet combining via (re) configure the TBS threshold or ON/OFF flag on whether packet combining is allowed. Alternatively, network can adjust the packet scheduling priority based on the reported time offset. Furthermore, the present disclosure introduces new assistance information where UE should report the packet combining status to network to enable efficient gNB scheduling.

According to the solution of the present disclosure, the solution enable the network to control the packet combining in UE based on network-defined threshold(s), hence network can control the required TBS and delay offset for VoIP packets uplink transmission. It is necessary to guarantee the UE can work well in the cell edge with uplink coverage bottleneck and to guarantee the Configured Grant feature can work well with the achievable gain (e.g. PDCCH saving and no PUSCH waste in CG occasions). The solution enable the UE report the packet combining status to network, which is to enable efficient gNB scheduling based on time-delay-based priority and/or required TBS to accommodate the combined speech frames.

FIG. 8 illustrates a schematic diagram illustrating a method of voice packet combination in accordance with some embodiments of the present disclosure. As shown in FIG. 8, in method of 800, at block 810, the terminal device 110 may receive, from the network device 120, control information for controlling voice packet combining at the terminal device. At block 820, the terminal device 110 may determine the voice packet combining based on the control information. At block 830, the terminal device 110 may perform the voice packet combining. At block 840, the terminal device 110 may transmit the combined voice packet to the network device.

In some embodiments, the terminal device 110 receives the control information by: receiving, from the network device, a TBS threshold for the voice packet combining at the terminal device. In some embodiments, the terminal device 110 performs the voice packet combining by determining a plurality of voice packets to be combined if the required Transport Block Size (TBS) to accommodate combined packets is less than the TBS threshold; and combining the plurality of voice packets into a single packet for uplink transmission.

In some embodiments, the method 800 further comprises transmitting, to the network device 120, radio channel conditions of the terminal device 110 for determining the TBS threshold by the network device 120. In some embodiments, the radio conditions can be RSRP or Reference Signal Receiving Quality (RSRQ) measured by the terminal device 110.

In some embodiments, the method 800 further comprises determining the number of voice packets to be combined in a single packet based on the TBS threshold and an applied voice codec rate. In some embodiments, the terminal device 110 receives the control information by receiving, from the network device, a time-delay threshold for the voice packet combining at the terminal device.

In some embodiments, the terminal device 110 performs the voice packet combining by determining a plurality of voice packets to be combined if an offset from the time of the packet generation to the time of the voice packet transmission is less than the time-delay threshold; and combining the plurality of voice packets into a single packet for uplink transmission.

In some embodiments, the terminal device 110 receives the control information by: receiving, from the network device, a Reference Signal Receiving Power (RSRP) threshold for the voice packet combining at the terminal device.

In some embodiments, the terminal device 110 performs the voice packet combining by determining the voice packet combining is allowed if a measured RSRP in the terminal device is higher than the RSRP threshold; and performing the voice packet combining.

In some embodiments, the terminal device 110 receives the control information by:

receiving, from the network device, a plurality of RSRP thresholds for the voice packet combining at the terminal device.

In some embodiments, the terminal device 110 performs the voice packet combining by determining, based on the plurality of RSRP thresholds, a packet combination level corresponding to a measured RSRP; and performing the voice packet combining based on the number of voice packets corresponding to the packet combination level.

In some embodiments, the terminal device 110 performs the voice packet combining by receiving, from the network device, a flag indicating whether the voice packet combining at the terminal device is allowed, and determining the voice packet combining at the terminal device is allowed; and performing the voice packet combining.

In some embodiments, wherein the voice packet is corresponding to a Voice over Internet Protocol (VoIP) speech frame. In some embodiments, the method 800 further comprises receiving the flag and one or more information of the control information via Radio Resource Control (RRC) or System Information Block (SIB).

In some embodiments, the method 800 further comprises reporting a status of the voice packet combining to the network device.

In some embodiments, the terminal device 110 reports the status of the voice packet combining by reporting the status of the voice packet combining based on determining that the number of Voice over Internet Protocol (VoIP) speech frames or the number of VoIP packets in a single packet for uplink transmission has changed or to be changed.

In some embodiments, the terminal device 110 reports the status of the voice packet combining by reporting the number of combined VoIP speech frames or the number of VoIP packets in a single packet for uplink transmission.

In some embodiments, the terminal device 110 reports the status of the voice packet combining by reporting the status of the voice packet combining based on determining that an offset from the time of the VoIP packet generation to the time of the voice packet transmission is changed or to be changed.

In some embodiments, the terminal device 110 reports the status of the voice packet combining by reporting the offset from the time of the VoIP packet generation to the time of the voice packet transmission.

In some embodiments, the terminal device 110 reports the status of the voice packet combining by reporting information indicating whether the voice packet combining is performed or to be performed.

In some embodiments, the terminal device 110 reports the status of the voice packet combining by reporting the status of the voice packet combining via Media Access Control Control Element (MAC CE) or RRC.

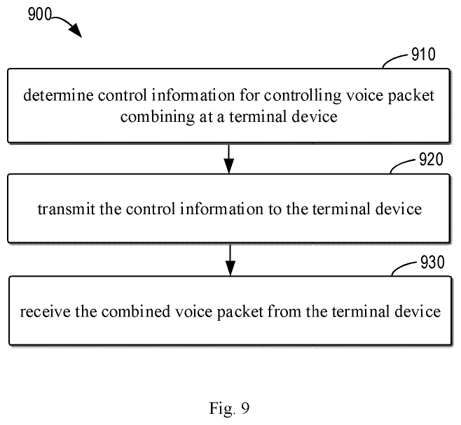

FIG. 9 illustrates a schematic diagram illustrating a method of voice packet combination in accordance with some embodiments of the present disclosure. As shown in FIG. 9, in method 900, at block 910, the network device 120 may determine control information for controlling voice packet combining at a terminal device. At block 920, the network device 120 may transmit the control information to the terminal device. At block 930, the network device 120 may receive the combined voice packet from the terminal device.

In some embodiments, the network device 120 determines the control information by receiving, from the terminal device, radio channel conditions of the terminal device; and determining a TBS threshold as the control information based on the radio channel conditions of the terminal device. In some embodiments, the network device 120 transmits the control information by transmitting the TBS threshold to the terminal device.

In some embodiments, the network device 120 determines the control information by determining a TBS threshold as the control information based on a configured TBS in Configured Grant (CG). In some embodiments, the network device 120 determines the control information by determining a time-delay threshold as the control information based on scheduling strategy of the network device, the scheduling strategy including scheduling priority for scheduling voice packets.

In some embodiments, the network device 120 transmits the control information by transmitting the time-delay threshold to the terminal device. In some embodiments, the network device 120 determines the control information by determining at least one RSRP threshold as the control information, a RSRP threshold corresponding to a packet combination level used for the terminal device to perform the voice packet combining.

In some embodiments, the network device 120 transmits the control information by transmitting the at least one RSRP threshold to the terminal device. In some embodiments, the method 900 further comprises transmitting, to the terminal device, a flag indicating whether the voice packet combining at the terminal device is allowed. In some embodiments, wherein the voice packet is corresponding to a Voice over Internet Protocol (VoIP) speech frame.

In some embodiments, the method 900 further comprises transmitting the flag and one or more information of the control information via Radio Resource Control (RRC) or System Information Block (SIB). In some embodiments, the method 900 further comprises receiving a report of status of the voice packet combining from the terminal device, the report including at least one of: the number of combined VoIP speech frames in a single packet for uplink transmission; the number of combined VoIP packets in a single packet for uplink transmission; an offset from the time of the VoIP packet generation to the time of the voice packet transmission at the terminal device; and information indicating whether the voice packet combining is performed or to be performed.

In some embodiments, the network device 120 receives a report of status of the voice packet combining by receiving the report via Media Access Control Control Element (MAC CE) or RRC. In some embodiments, the method 900 further comprises updating the control information based on the report.

In some embodiments, an apparatus capable of performing any of the method 800 (for example, the terminal device 120) may comprise means for performing the respective steps of the method 800. The means may be implemented in any suitable form. For example, the means may be implemented in a circuitry or software module.

In some embodiments, the apparatus comprises means for receiving, at a terminal device from a network device, control information for controlling voice packet combining at the terminal device; means for determining the voice packet combining based on the control information; means for performing the voice packet combining; and means for transmitting the combined voice packet to the network device.

In some embodiments, the means for receiving the control information comprises: means for receiving, from the network device, a TBS threshold for the voice packet combining at the terminal device. In some embodiments, the means for performing the voice packet combining comprises means for determining a plurality of voice packets to be combined if the required Transport Block Size (TBS) to accommodate combined packets is less than the TBS threshold; and means for combining the plurality of voice packets into a single packet for uplink transmission.

In some embodiments, the apparatus further comprises means for transmitting, to the network device, radio channel conditions of the terminal device for determining the TBS threshold by the network device. In some embodiments, the apparatus further comprises means for determining the number of voice packets to be combined in a single packet based on the TBS threshold and an applied voice codec rate.

In some embodiments, the means for receiving the control information comprises means for receiving, from the network device, a time-delay threshold for the voice packet combining at the terminal device. In some embodiments, the means for performing the voice packet combining comprises means for determining a plurality of voice packets to be combined if an offset from the time of the packet generation to the time of the voice packet transmission is less than the time-delay threshold; and means for combining the plurality of voice packets into a single packet for uplink transmission.

In some embodiments, the means for receiving the control information comprises means for receiving, from the network device, a Reference Signal Receiving Power (RSRP) threshold for the voice packet combining at the terminal device. In some embodiments, the means for performing the voice packet combining comprises means for determining the voice packet combining is allowed if a measured RSRP in the terminal device is higher than the RSRP threshold; and means for performing the voice packet combining.

In some embodiments, the means for receiving the control information comprises means for receiving, from the network device, a plurality of RSRP thresholds for the voice packet combining at the terminal device. In some embodiments, the means for performing the voice packet combining comprises means for determining, based on the plurality of RSRP thresholds, a packet combination level corresponding to a measured RSRP; and means for performing the voice packet combining based on the number of voice packets corresponding to the packet combination level.

In some embodiments, the means for performing the voice packet combining comprises means for receiving, from the network device, a flag indicating whether the voice packet combining at the terminal device is allowed; and determining the voice packet combining at the terminal device is allowed; and means for performing the voice packet combining. In some embodiments, wherein the voice packet is corresponding to a Voice over Internet Protocol (VoIP) speech frame.

In some embodiments, the apparatus further comprises means for receiving the flag and one or more information of the control information via Radio Resource Control (RRC) or System Information Block (SIB). In some embodiments, the apparatus further comprises means for reporting a status of the voice packet combining to the network device.

In some embodiments, the means for reporting the status of the voice packet combining comprises means for reporting the status of the voice packet combining based on determining that the number of Voice over Internet Protocol (VoIP) speech frames in a single packet for uplink transmission has changed or to be changed. In some embodiments, the means for reporting the status of the voice packet combining comprises means for reporting the number of combined VoIP speech frames in a single packet for uplink transmission.

In some embodiments, the means for reporting the status of the voice packet combining comprises means for reporting the status of the voice packet combining based on determining that an offset from the time of the VoIP packet generation to the time of the voice packet transmission is changed or to be changed.

In some embodiments, the means for reporting the status of the voice packet combining comprises means for reporting the offset from the time of the VoIP packet generation to the time of the voice packet transmission. In some embodiments, the means for reporting the status of the voice packet combining comprises means for reporting information indicating whether the voice packet combining is performed or to be performed. In some embodiments, the means for reporting the status of the voice packet combining comprises means for reporting the status of the voice packet combining via Media Access Control Control Element (MAC CE) or RRC.

In some embodiments, the apparatus further comprises means for performing other steps in some embodiments of the method 800. In some embodiments, the means comprises at least one processor; and at least one memory including computer program code, the at least one memory and computer program code configured to, with the at least one processor, cause the performance of the apparatus.

In some embodiments, an apparatus capable of performing any of the method 900 (for example, the network device 120) may comprise means for performing the respective steps of the method 900. The means may be implemented in any suitable form. For example, the means may be implemented in a circuitry or software module.

In some embodiments, the apparatus comprises: means for determining, at a network device, control information for controlling voice packet combining at a terminal device; means for transmitting the control information to the terminal device; and means for receiving the combined voice packet from the terminal device.

In some embodiments, the means for determining the control information comprises means for receiving, from the terminal device, radio channel conditions of the terminal device; and determining a TBS threshold as the control information based on the radio channel conditions of the terminal device. In some embodiments, the means for transmitting the control information comprises means for transmitting the TBS threshold to the terminal device.

In some embodiments, the means for determining the control information comprises means for determining a TBS threshold as the control information based on a configured TBS in Configured Grant (CG). In some embodiments, the means for determining the control information comprises means for determining a time-delay threshold as the control information based on scheduling strategy of the network device, the scheduling strategy including scheduling priority for scheduling voice packets.

In some embodiments, the means for transmitting the control information comprises means for transmitting the time-delay threshold to the terminal device. In some embodiments, the means for determining the control information comprises means for determining at least one RSRP threshold as the control information, a RSRP threshold corresponding to a packet combination level used for the terminal device to perform the voice packet combining;

In some embodiments, the means for transmitting the control information comprises means for transmitting the at least one RSRP threshold to the terminal device. In some embodiments, the apparatus further comprises means for transmitting, to the terminal device, a flag indicating whether the voice packet combining at the terminal device is allowed.

In some embodiments, wherein the voice packet is corresponding to a Voice over Internet Protocol (VoIP) speech frame. In some embodiments, the apparatus further comprises means for transmitting the flag and one or more information of the control information via Radio Resource Control (RRC) or System Information Block (SIB).

In some embodiments, the apparatus further comprises means for receiving a report of status of the voice packet combining from the terminal device, the report including at least one of: the number of combined VoIP speech frames in a single packet for uplink transmission; the number of combined VoIP packets in a single packet for uplink transmission; an offset from the time of the VoIP packet generation to the time of the voice packet transmission at the terminal device; and information indicating whether the voice packet combining is performed or to be performed.

In some embodiments, means for receiving a report of status of the voice packet combining comprises receiving the report via Media Access Control Control Element (MAC CE) or RRC. In some embodiments, the apparatus further comprises means for updating the control information based on the report.

In some embodiments, the apparatus further comprises means for performing other steps in some embodiments of the method 900. In some embodiments, the means comprises at least one processor; and at least one memory including computer program code, the at least one memory and computer program code configured to, with the at least one processor, cause the performance of the apparatus.

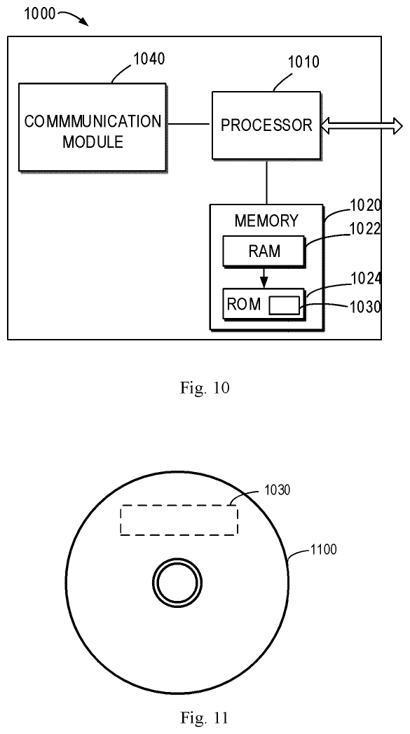

FIG. 10 is a simplified block diagram of a device 1000 that is suitable for implementing embodiments of the present disclosure. The device 1000 may be provided to implement the communication device, for example the terminal device 110, the network device 120 as shown in FIG. 1. As shown, the device 1000 includes one or more processors 1010, one or more memories 1040 coupled to the processor 1010, and one or more communication modules 1040 coupled to the processor 1010.

The communication module 1040 is for bidirectional communications. The communication module 1040 has at least one antenna to facilitate communication. The communication interface may represent any interface that is necessary for communication with other network elements.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The program 1030 may be stored in the ROM 1020. The processor 1010 may perform any suitable actions and processing by loading the program 1030 into the RAM 1020.

The embodiments of the present disclosure may be implemented by means of the program 1030 so that the device 1000 may perform any process of the disclosure as discussed with reference to FIGS. 2 to 9. The embodiments of the present disclosure may also be implemented by hardware or by a combination of software and hardware.

In some embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. The computer readable medium may include any types of tangible non-volatile storage, such as ROM, EPROM, a flash memory, a hard disk, CD, DVD, and the like. FIG. 11 shows an example of the computer readable medium 1100 in form of CD or DVD. The computer readable medium has the program 1030 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 1000 as described above with reference to FIGS. 2-5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device comprising:
at least one processor; and
at least one memory storing instructions that, when executed by the at least one processor, cause the terminal device at least to:
receive, from a network device, control information for controlling voice packet combining at the terminal device:
determine the voice packet combining based on the control information:
perform the voice packet combining; and
transmit the combined voice packet to the network device.

2. The terminal device of claim 1, wherein:
the terminal device is caused to receive the control information by:
receive, from the network device, a Transport Block Size (TBS) threshold for the voice packet combining at the terminal device:
the terminal device is caused to perform the voice packet combining by:
determining a plurality of voice packets to be combined if the required TBS to accommodate combined packets is less than the TBS threshold; and
combining the plurality of voice packets into a single packet for uplink transmission.

3. The terminal device of claim 2, wherein the terminal device is further caused to:
transmit, to the network device, radio channel conditions of the terminal device for determining the TBS threshold by the network device.

4. The terminal device of claim 2, wherein the terminal device is further caused to:
determine the number of voice packets to be combined in a single packet based on the TBS threshold and an applied voice codec rate.

5. The terminal device of claim 1, wherein:
the terminal device is caused to receive the control information by:
receiving, from the network device, a time-delay threshold for the voice packet combining at the terminal device:
the terminal device is caused to perform the voice packet combining by:
determining a plurality of voice packets to be combined if an offset from the time of the packet generation to the time of the voice packet transmission is less than the time-delay threshold; and
combining the plurality of voice packets into a single packet for uplink transmission.

6. The terminal device of claim 1, wherein:
the terminal device is caused to receive the control information by:
receiving, from the network device, a Reference Signal Receiving Power (RSRP) threshold for the voice packet combining at the terminal device:
the terminal device is caused to perform the voice packet combining by:
determining the voice packet combining is allowed if a measured RSRP in the terminal device is higher than the RSRP threshold; and
performing the voice packet combining.

7. The terminal device of claim 1, wherein:
the terminal device is caused to receive the control information by:
receiving, from the network device, a plurality of Reference Signal Receiving Power (RSRP) thresholds for the voice packet combining at the terminal device:
the terminal device is caused to perform the voice packet combining by:
determining, based on the plurality of RSRP thresholds, a packet combination level corresponding to a measured RSRP; and
performing the voice packet combining based on the number of voice packets corresponding to the packet combination level.

8. The terminal device of claim 1, wherein the terminal device is caused to perform the voice packet combining by:
receive, from the network device, a flag indicating whether the voice packet combining at the terminal device is allowed;
determine the voice packet combining at the terminal device is allowed; and
perform the voice packet combining.

9. The terminal device of claim 1, wherein the voice packet is corresponding to a Voice over Internet Protocol (VoIP) speech frame.

10. The terminal device of claim 1, wherein the terminal device is further caused to:
receive the flag and one or more information of the control information via Radio Resource Control (RRC) or System Information Block (SIB).

11. The terminal device of claim 1, wherein the terminal device is further caused to:
report a status of the voice packet combining to the network device.

12. The terminal device of claim 11, wherein the terminal device is caused to report the status of the voice packet combining by:
reporting the status of the voice packet combining based on determining that the number of Voice over Internet Protocol (VoIP) speech frames in a single packet for uplink transmission has changed or to be changed.

13. The terminal device of claim 11- or 12, wherein the terminal device is caused to report the status of the voice packet combining by:
reporting the number of combined VoIP speech frames in a single packet for uplink transmission.

14. The terminal device of claim 11, wherein the terminal device is caused to report the status of the voice packet combining by:
reporting the status of the voice packet combining based on determining that an offset from the time of the VoIP packet generation to the time of the voice packet transmission is changed or to be changed.

15. The terminal device of claim 11, wherein the terminal device is caused to report the status of the voice packet combining by:
reporting the offset from the time of the VoIP packet generation to the time of the voice packet transmission.

16. The terminal device of claim 11, wherein the terminal device is caused to report the status of the voice packet combining by:
reporting information indicating whether the voice packet combining is performed or to be performed.

17. The terminal device of claim 11, wherein the terminal device is caused to report the status of the voice packet combining by:
reporting the status of the voice packet combining via Media Access Control Control Element (MAC CE) or RRC.

18. A network device comprising:
at least one processor; and
at least one memory storing instructions that, when executed by the at least one processor, cause the network device at least to:
determine control information for controlling voice packet combining at a terminal device;
transmit the control information to the terminal device; and
receive the combined voice packet from the terminal device.

19-28. (canceled)

29. A method comprising:
receiving, at a terminal device from a network device, control information for controlling voice packet combining at the terminal device:
determining, by the terminal device, the voice packet combining based on the control information:
performing, by the terminal device, the voice packet combining; and
transmitting, by the terminal device, the combined voice packet to the network device.

30-33. (canceled)
